(19) United States
(12) Patent Application Publication
(10) Pub. No.: US 2004/0174438 A1
(43) Pub. Date: Sep. 9, 2004

(54) Video communication terminal for displaying user's face at the center of its own display screen and method for controlling the same

(75) Inventor: Chae-Sung Jung, Suwon-shi (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/779,449

(22) Filed: Feb. 13, 2004

(30) Foreign Application Priority Data
Mar. 7, 2003 (KR) 14357/2003

(51) Int. Cl. H04N 5/225; H04N 5/222

(52) U.S. Cl. 348/222.1; 348/172; 348/333.12; 348/333.04

(57) ABSTRACT

A video communication terminal for displaying a user's face at the center of its own display screen and a method for controlling the same. The communication terminal with a camera transmits a captured image to a communication terminal of a called party, and displays an image received from the called party's communication terminal thereon such that it establishes a video communication with the called party. A transmission/reception unit performs data transmission/reception for the video communication. A tracker detects a user's face area from an image captured by the camera. An image extractor extracts pixels of a predetermined range covering the user's face area detected by the tracker. A distortion corrector corrects a distortion of angle of view in the pixels extracted by the image extractor when the camera captures an image. A controller controls the transmission/reception unit to transmit an image having no distortion of angle of view through the distortion corrector to the called party's communication terminal. Therefore, the user's face area is always positioned at the center of a display screen.

### PRIORITY

This application claims priority to an application entitled “COMMUNICATION TERMINAL AND METHOD CAPABLE OF DISPLAYING FACE IMAGE OF USER AT THE MIDDLE PART OF SCREEN”, filed in the Korean Industrial Property Office on Mar. 7, 2003 and assigned Serial No. 2003-14357, the contents of which are hereby incorporated by reference.

### BACKGROUND OF THE INVENTION

1. Field of the Invention

The present invention relates to a communication terminal for video communication, and more particularly to a communication terminal for displaying at the center of its own display screen a face of a user visually communicating with a called party.

2. Description of the Related Art

With the increasing development of digital camera technologies, a variety of video communication terminals with digital cameras have been rapidly developed and widely spread as a new communication terminal. In the case where a video communication terminal captures a still image using its own digital camera, the quality of the captured still image increases in proportion to the number of pixels. However, in the case where the video communication terminal captures moving images using its own digital camera at a high resolution, an excessive amount of data is created, resulting in the difficulty in processing the captured data.

In addition, the video communication terminal has a difficulty in fully displaying a high-quality image captured by the digital camera on its own small-sized LCD serving as a display screen. Therefore, the conventional video communication terminal reduces an overall resolution of the resultant image captured by the digital camera to lessen an amount of captured data down to a prescribed amount of data, such that it reduces the amount of overall data and maintains a prescribed data processing speed in a video communication mode. Alternatively, the communication terminal selects only a screen image within a predetermined range from among the center part of the display screen, and then adapts only the selected image as video communication data, in such a way that it reduces the amount of overall data in a video communication mode.

The video communication terminal transmits an image captured by its own digital camera to a called communication terminal in a video communication mode, or receives a captured image from the called communication terminal in the video communication mode. Typically, a user (i.e., a caller) holds a video communication terminal in his or her palm, extends his or her arm, captures his or her face image using a digital camera held in his or her hand, and sends a captured face image to the communication terminal of the called party. In this case, the captured face image is displayed on his or her terminal LCD screen by a user's command in such a way that the user visually checks the captured face image, and at the same time manually controls his or her digital camera to allow his or her face image to be more clearly captured by the digital camera.

However, in the case where the user visually communicates with the called party while viewing the captured images, it is very difficult for the user to manually control his or her face image to be always displayed at the center of a display screen such as an LCD due to trembling and the difference between a position of a digital camera lens and a position of an LCD displaying the captured user's face image. Considering that an important advantage of the video communication terminal is to satisfy a user who wishes to visually and audibly establish a call connection state with the called party, it will be more preferable for the user's captured face image to be placed at the center of the display screen.

Therefore, in order to satisfy the user's desires, a captured image of the user (i.e., caller) is continuously displayed on the LCD window to allow the caller to visually check his or her captured image, such that the captured image of the caller can be transferred to a communication terminal of the called party according to the visual checking results. However, in this case, the conventional video communication terminal must partially occupy the LCD window used for displaying an image transmitted from a communication terminal of the called party and display a captured image of a caller on the occupied part of the LCD window, and a sub LCD window for displaying a captured image of the caller thereon should be additionally mounted to the video communication terminal. Although the sub LCD window is adapted to the communication terminal to check the captured image of the caller, the caller must manually and frequently control a communication terminal and/or a digital camera to place his or her face image at the center of the captured image while visually checking his or her face image displayed on the sub LCD window.

In order to solve the aforementioned disadvantages of the conventional video communication terminal, an image stabilization scheme for removing screen trembling in the conventional video communication terminal such as a camcorder is adapted to a communication terminal, resulting in no screen trembling in the conventional video communication terminal such as a camcorder, etc. The image stabilization scheme solves such screen trembling caused by an unintentional trembling of a user's hand or a communication terminal, resulting in the improvement of image quality. Representative examples related to the image stabilization scheme have been disclosed in Korean Patent Nos. 256112, 285948, 218020, and 163916, which are incorporated herein by reference. Provided that this image stabilization scheme is adapted to the communication terminal, it is still difficult for the communication terminal to place a caller's face at the center of a display screen using a digital camera needed to execute a video communication function even though a screen trembling is compensated for.

In order to solve the aforementioned disadvantages of the conventional video communication terminal, there has been proposed a method for tracking a target object by directly driving a motor after sensing an image captured as denoted by FIG. 1. Referring to FIG. 1, a communication terminal 10 contains a camera 20 rotatably moveable in all directions (i.e., up, down, left, and right directions). FIG. 1(a) is a front view of the camera 20, FIG. 1(b) is a left-sided view of the camera 20, and FIG. 1(c) is a plane view of the camera 20. In more detail, FIGS. 1(a) and 1(c) show the left/right rotation of the camera 20, and FIG. 1(b) shows the up/down rotation of the camera 20.

However, the aforementioned method for controlling a moving direction of the camera using a motor has a disadvantage in that it is difficult to manufacture a small-sized and lightweight communication terminal due to a mechanical structure, and the communication terminal connected to the camera should be fixed to a predetermined point within a prescribed range. In conclusion, it is difficult to adapt this aforementioned method to the communication terminal.

### SUMMARY OF THE INVENTION

Therefore, the present invention has been made in view of the above problems, and it is an object of the present invention to provide a video communication terminal for displaying at the center of its own display screen, a face image of a caller who visually communicates with a callee, and more easily transmitting the caller's face image to the callee, and a method for displaying at the center of the display screen of the communication terminal a face area of the caller.

It is another object of the present invention to provide a communication terminal for positioning at the center of a display screen a captured face image of a caller while maintaining image data capacity needed to maintain a transfer rate required for displaying a moving image in a video communication mode, and a method for displaying at the center of a display screen of the communication terminal a face image of a caller.

It is yet another object of the present invention to provide a communication terminal having no additional sub display screen such that there is no need for the communication terminal to check a caller's image in a video communication mode as well as to separate some part from the display screen, and a method for displaying at the center of a display screen of the communication terminal a face image of a caller.

In accordance with the present invention, the above and other objects can be accomplished by the provision of a communication terminal apparatus with a camera for transmitting a captured image to a communication terminal of a called party, and displaying an image received from the called party's communication terminal thereon such that it establishes a video communication with the called party, including: a transmission/reception unit for performing data transmission/reception for the video communication; a tracker for detecting a user's face area from an image captured by the camera; an image extractor for extracting pixels of a predetermined range covering the user's face area detected by the tracker; a distortion corrector for correcting a distortion of angle of view in the pixels extracted by the image extractor when the camera captures an image; and a controller for determining whether a setup shot mode is a self-view mode for capturing the user, controlling the shot mode of the camera at the self-view mode when the setup shot mode is the self-view mode, and controlling the transmission/reception unit to transmit an image having no distortion of angle of view through the distortion corrector to the called party's communication terminal.

Preferably, the tracker detects a center point of the user's face area extracted from the captured image of the camera, and the image extractor extracts predetermined pixels covering the user's face area on the basis of the center point of the user's face area, and constructs a screen image using only the extracted pixels.

Preferably, the controller determines whether the user's face area detected by the tracker is in a prescribed allowable range, and determines whether a user's face area corresponding to the pixels corrected by the distortion corrector is in a prescribed allowable range. If the user's face area detected by the tracker is outside of the prescribed allowable range, or the user's face area corresponding to the pixels corrected by the distortion corrector is outside of the prescribed allowable range, the controller controls the transmission/reception unit to prevent the image having no distortion of angle of view from being transmitted.

Preferably, the apparatus further includes an alarm signal generator for generating an alarm signal recognizable to the user upon receiving a control signal from the controller. If the user's face area detected by the tracker is outside of the prescribed allowable range, or the user's face area corresponding to the pixels corrected by the distortion corrector is outside of the prescribed allowable range, the controller controls the alarm signal generator to output the alarm signal.

In accordance with another aspect of the present invention, there is provided a method for displaying a user's face area at the center of a display screen in a communication terminal apparatus with a camera for transmitting a captured image to a communication terminal of a called party, and displaying an image received from the called party's communication terminal thereon to establish a video communication with the called party, including the steps of: a) detecting the user's face area from an image captured by the camera; b) selecting pixels of a predetermined range covering the detected user's face area; c) correcting a distortion of angle of view in an image corresponding to the pixels covering the user's face area when the camera captures an image; and d) transmitting an image having no distortion of angle of view to the called party's communication terminal.

Preferably, the method further includes the step of: e) detecting a center point of the user's face area extracted from the captured image of the camera after performing step (a), wherein step (b) further includes the step of extracting predetermined pixels covering the user's face area on the basis of the center point of the user's face area.

Preferably, the method further includes the steps of: f) determining whether the user's face area detected at step (a) is in a prescribed allowable range after performing step (c), determining whether the user's face area corresponding to the pixels corrected at step (c) is in a prescribed allowable range; and (g) if the user's face area is outside of the prescribed allowable range, or the user's face area corresponding to the pixels is outside of the prescribed allowable range, preventing the image having no distortion of angle of view from being transmitted to the called party's communication terminal.

Preferably, the method further includes the step of: (h) if the user's face area is outside of the prescribed allowable range at step (f), or an image area corresponding to the pixels covering the user's face area is outside of the prescribed allowable range, outputting an alarm signal recognizable to the user.

In the case of a self-view mode at which the user can pick up his or her image alone, the present invention maximizes the angle of view of a camera lens to set up a display mode of a maximal resolution, and recognizes the user's face image from a captured image of the camera. The pixels oriented from the center point of the recognized user's face image are extracted with a prescribed resolution, and then adapted to a moving image transmission mode, resulting in obtaining data proper to a moving image transmission, and always placing the user's face image at the center of a display screen in a video communication mode. In the case of the self-view mode, the present invention selectively processes pixels of a predetermined area having the user's face area from among image data captured with a maximal angle of view and maximal resolution, and obtains the size of data proper to a moving image transmission mode, such that a needed transfer rate for a video communication can be maintained with a low resolution. Besides, the present invention reduces a captured image's trembling caused by a hand trembling or terminal's trembling. The present invention does not require an additional sub LCD to allow the user to visually check his or her captured image, nor does it require the use of some part of a display screen to display a user's captured image on some part of the display screen, resulting in increasing a screen usage efficiency of a communication terminal, and enabling a manufactured product to be light in weight.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary view illustrating a conventional communication terminal for sensing a captured image, and directly driving a motor to track a target object;

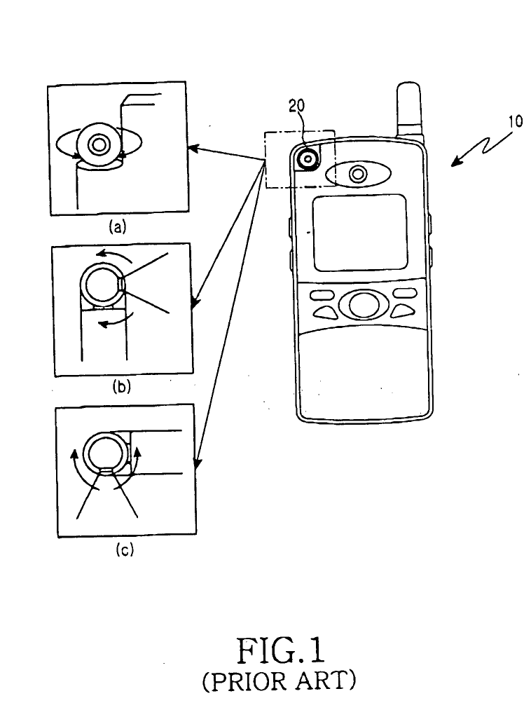

FIG. 2 is a block diagram illustrating a communication terminal for displaying a captured face image at the center of a display screen in accordance with a preferred embodiment of the present invention;

FIGS. 3a to 3e are views illustrating display examples of individual images on the condition that images changed by individual components shown in FIG. 2 are displayed on a display screen; and

FIG. 4 is a flow chart illustrating a method for displaying a captured face image at the center of the display screen using the communication terminal in accordance with a preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

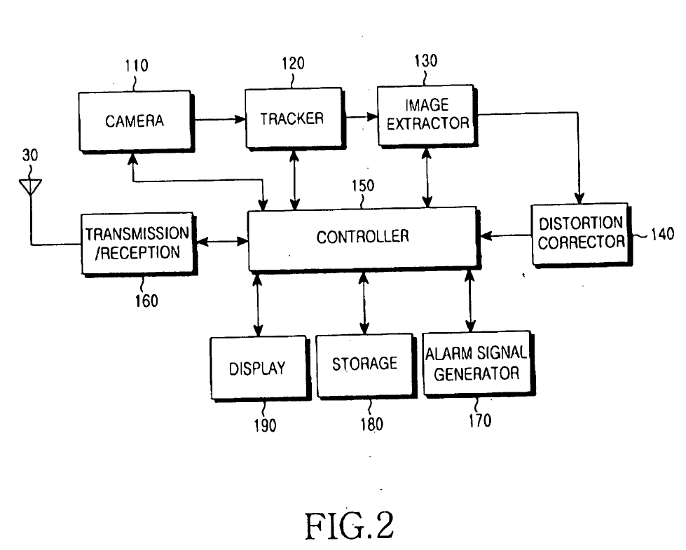

FIG. 2 is a block diagram illustrating a communication terminal for displaying at the center of a display screen a captured face image in accordance with a preferred embodiment of the present invention. Firstly, it should be noted that basic function modules mounted to the communication terminal to perform communications and their detailed description will herein be omitted.

Referring to FIG. 2, the communication terminal includes a camera 110, a tracker 120, an image extractor 130, a distortion corrector 140, a controller 150, a transmission/reception unit 160, an alarm signal generator 170, a storage unit 180, and a display 190.

The camera 110 captures an image. According to the present invention, the camera 110 makes prescribed shot preparations for the self-view mode when a shot mode is set to a self-view mode. It is preferable for the camera 10 to maximize an angle of view as well as to minimize a focal length such that a subject is captured by the camera 10 in a wider range of fields. For example, provided that a wide-angle lens (not shown) or a fisheye lens (not shown) is adapted to the camera 110, an angle of view of 180° can be captured by either the wide-angle lens or the fisheye lens, however resulting in increased distortion of a real subject image. This distortion is corrected by a distortion corrector 140.

The tracker 120 extracts a face area of a user from among the captured image of the camera 110. There have been proposed a variety of techniques for extracting a user's face image from among the captured image, for example, a face outline extraction technique, a center point tracking technique, and a correlation tracking technique, etc. These techniques are well known to those skilled in the art. In more detail, the center point tracking technique converts background or object data into binary data using a threshold value in order to separate a target subject from a background in such a way that a center point of the target subject is tracked. The correlation tracking technique defines an area of a predetermined size at a position of a target subject (i.e., a moving subject) of a previous frame, calculates a correlation between the prescribed area of the previous frame and a search area of a current frame, and determines that the target subject moves to the highest-correlation area. In the meantime, the tracker 120 may detect a center point of a face area on the basis of the extracted user's face area.

The image extractor 130 extracts a preset number of pixels from a prescribed area upon receiving the user's face image or the center point data of the user's face area from the tracker 120. In this case, the extracted pixels are defined as a specific image to be transmitted to a called party in a video communication mode. For example, provided that a captured image of the camera 110 has three million pixels, the image extractor 130 extracts three hundred thousand pixels from a face area detected by the tracker 120, and constructs an image to be displayed on a display 190. In more detail, the image extractor 130 extracts a prescribed part in the vicinity of a user's face from among the captured image of the camera 110, resulting in reduction of an amount of transmission data in a video communication mode, and maintaining a prescribed transfer rate required for a video communication mode.

Upon receiving an image involving the user's face area extracted by the image extractor 130, the distortion corrector 140 corrects a distortion of an angle of view in a captured image of the camera 110. This distortion of angle of view is created by a shot operation of the camera 110. In more detail, in order to compensate the distortion of angle of view in an image captured by a lens (i.e., a wide-angle lens) adapted to form an image of a target subject in a wider range, the distortion corrector 140 corrects the distortion of angle of view of the captured image using position vectors of individual pixels ranging from the center part of a real image to an image extracted by the image extractor 130. Therefore, the resultant image corrected by the distortion corrector 140 is displayed on the display 190 in the same form as that of the real image.

The controller 150 controls an overall operation of a communication terminal. The controller 150 determines whether a command for enabling a video communication mode (hereinafter referred to as a video communication command) is entered by a user. If it is determined that the video communication command is entered, then the controller 150 determines whether the video communication command is a command for a self-view mode for enabling the user to directly capture his or her face image. In this case, if it is determined that the video communication command is the self-vide mode command, the controller 150 controls the camera 110 to make shot preparations for the self-view mode.

The transmission/reception unit 160 transmits an image corrected by the distortion corrector 140 to a communication terminal of the called party through an antenna 30 according to a control signal of the controller 150. The transmission/reception unit 160 receives an image transmitted from the called party's communication terminal, and transmits the reception image to the controller 150. Therefore, the controller 150 controls the display 190 to display the reception image.

An alarm signal generator 170 generates a variety of alarm signals recognizable to the user, for example, sound, voice information message, information text, and a prescribed character, etc.

On the other hand, the controller 150 determines whether a face area and its center point extracted from the captured image of the camera 110 are those contained in a prescribed allowable range. In this case, if it is determined that the face area and its center point extracted by the tracker 120 are outside of the allowable range, the controller 150 controls the alarm signal generator 170 to output an alarm signal.

The controller 150 determines whether an output image (i.e., a corrected image) of the distortion corrector 140 for correcting the distortion of angle of view in the user's face image generated from the image extractor 130 is contained in a prescribed allowable range of the distortion of angle of view. In this case, if it is determined that the output image of the distortion corrector 140 is outside of the allowable range of the distortion of angle of view, the controller 150 controls the alarm signal generator 170 to output an alarm signal.

Therefore, if the alarm signal generator 170 outputs the alarm signal, the user resets a position of the camera 110.

The storage unit 170 temporarily stores a drive program for controlling the controller 150 and data created by any control function of the controller 150. The storage unit 170 may store an image captured by the camera 110 or an image corrected by the distortion corrector 140.

The display 190 displays an image received from a communication terminal of the called party upon receiving a control signal from the controller 150.

Therefore, a user's face area is extracted from the captured image of the camera 110, predetermined pixels having the user's face area are also extracted and then displayed on a screen of the display 190, such that the user's face area can be always positioned at the center of the display 190 screen. In addition, pixels of a predetermined area having the user's face area are extracted from the captured image data of the camera 110 and the extracted pixels are used for a video communication, such that the user's face area can be always displayed at the center of the display screen and at the same time a needed transfer rate can be maintained. Further, the captured image's trembling created by a user's hand trembling or a terminal's trembling may be reduced. The present invention does not require an additional sub LCD to visually check a user's captured image in a video communication mode, nor does it require the partial use of a display screen to enable the user to visually check his or her captured image.

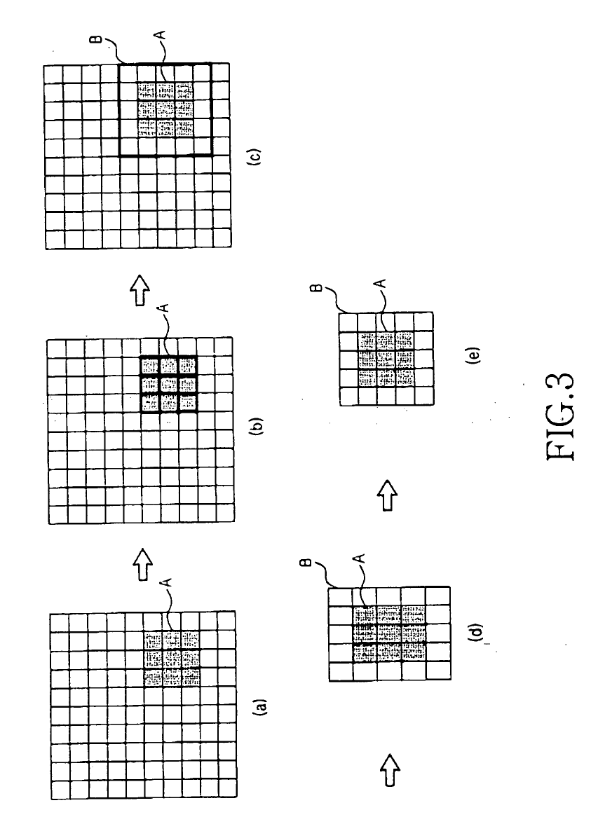

FIGS. 3a to 3e are views illustrating display examples of individual images on the condition that images changed by individual components shown in FIG. 2 are displayed on a display screen.

FIG. 3a is an entire screen view shown when an image captured by the camera 110 is displayed on a screen. As shown in FIG. 3a, it is noted that a user's face area A is offset from the center part of the screen. FIG. 3b is a display screen view shown when the user's face area A is detected by the tracker 120 from among the captured image of the camera 110. FIG. 3c is a view illustrating a face area having the user's face area A detected by the tracker 120 and predetermined pixels B oriented from the center point of the user's face area, that are selected by the image extractor 130. FIG. 3d is a view wherein the pixels B selected by the image extractor 130 are displayed on an entire display screen, resulting in reducing data capacity for a video communication. The image of FIG. 3d contains the distortion of angle of view. FIG. 3e is a view wherein a final output image having no distortion of angle of view through the distortion corrector 140 is displayed on an entire display screen. Therefore, in the case of displaying a correction image outputted from the distortion corrector 140, the user's face area A is placed at the center of the display screen.

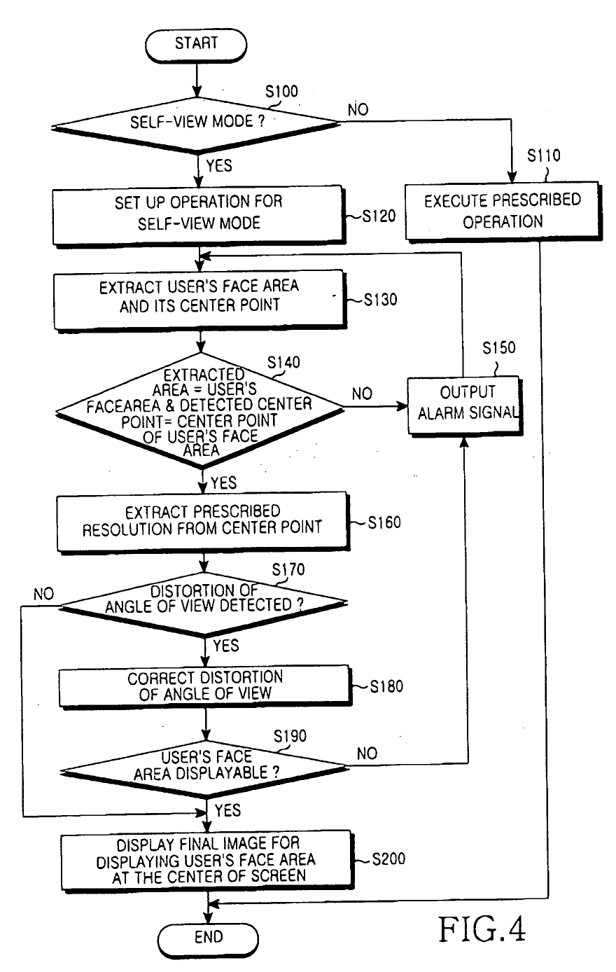

FIG. 4 is a flow chart illustrating a method for displaying a captured face image at the center of the display screen using the communication terminal in accordance with a preferred embodiment of the present invention.

Referring to FIG. 4, the controller 150 determines whether a shot mode command entered by a user is set to a self-view mode at step S100. If the shot mode command is not set to the self-view mode at step S100, the controller 150 executes a prescribed corresponding operation at step S110. If the shot mode command is set to the self-view mode at step S100, the controller 150 controls the camera 110 to make shot preparations for the self-view mode at step S 120, such that the camera 110 sets up a prescribed function for the self-view mode.

The camera 110 picks up a target subject at the self-view mode, and transmits a captured image of the target subject to the tracker 120. The tracker 120 extracts a user's face area from the captured image of the camera 110, and detects a face area and/or its center point from the extracted user's face area at step S130. In this case, the tracker 120 transmits the user's face area received from the image extractor 130 and its own center point image to the controller 150. Therefore, the controller 150 determines whether the user's face area received from the tracker 120 and the center point image of the user's face area are in a prescribed allowable range at step S140.

If it is determined at step S140 that the user's face area and its center point image are outside of the prescribed allowable range, the controller 150 controls the alarm signal generator 150 to output an alarm signal at step S150. Otherwise, if it is determined at step S140 that the user's face area and its center point image are in the prescribed allowable range, the controller 150 controls the image extractor 130 to extract predetermined pixels oriented from the center point of the user's face area at step S160.

The distortion corrector 140 determines whether the distortion of angle of view of the camera 110 occurs in the pixels extracted from the image extractor 130 at step S170. If it is determined at step S170 that the distortion of angle of view occurs in the pixels, the distortion corrector 140 corrects the distortion of angle of view in an image corresponding to the extracted pixels at step S180. In this case, the controller 150 determines at step S190 whether an image having no distortion of angle of view involves the user's face area in order to allow the user's face area to be displayed on the display screen. If it is determined at step S190 that the user's face area is unable to be displayed on the display screen, the controller 150 controls the alarm signal generator 170 to output an alarm signal at step S150.

If it is determined that the image having no distortion of angle of view contains the user's face area such that the user's face area can be displayed on the display screen, the controller 150 controls the display 190 to display the final resultant image where the user's face area is positioned at the center of the display screen at step S200.

In this way, a user's face area is extracted from an image captured by the camera 110, prescribed pixels having the user's face area are also extracted and displayed on a display screen, such that the user's face area can be always positioned at the center of the display screen. The present invention selects pixels of a predetermined area having a user's face area from among plurality of image data captured by the camera 110 and adapts the selected pixels to a video communication mode, such that the user's face area can be always positioned at the center of the display screen, while simultaneously maintaining a needed transfer rate.

In accordance with the preferred embodiment of the present invention, although the tracker 120 detects a user's face area and its own center point in such a way that a resolution in only a prescribed area oriented from the center point is calculated, a variety of image extraction techniques such as an outline extraction technique may be adapted to extract the user's face area. In addition, provided that various schemes capable of extracting such a user's face area from the captured image of the camera are designed to detect only the user's face area, they are applicable to the present invention even though the center point of the user's face area is not extracted.

As apparent from the above description, in the case of a self-view mode at which the user can pick up his or her image alone, the present invention maximizes the angle of view of a camera lens to set up a display mode of a maximal resolution, and recognizes the user's face image from a captured image of the camera. The pixels oriented from the center point of the recognized user's face image are extracted with a prescribed resolution, and then adapted to a moving image transmission mode, resulting in obtaining data proper to a moving image transmission, and always placing the user's face image at the center of a display screen in a video communication mode.

Further, in the case of the self-view mode, the present invention selectively processes pixels of a predetermined area having the user's face area from among image data captured with a maximal angle of view and maximal resolution, and obtains the size of data proper to a moving image transmission mode, such that a needed transfer rate for a video communication can be maintained with a low resolution.

Besides, the present invention reduces a captured image's trembling caused by a hand trembling or terminal's trembling. The present invention does not require an additional sub LCD to allow the user to visually check his or her captured image, nor does it require the use of some part of a display screen to display a user's captured image on some part of the display screen, resulting in increasing a screen usage efficiency of the communication terminal, and enabling a manufactured product to be light in weight.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A communication terminal apparatus having a camera for transmitting a captured image to a communication terminal of a called party, and having a display for displaying an image received from the called party's communication terminal thereon such that it establishes a video communication with the called party, comprising:
a transmission/reception unit for performing data transmission/reception for the video communication;
a tracker for detecting a user's face area from an image captured by the camera;
an image extractor for extracting pixels of a predetermined range covering the user's face area detected by the tracker;
a distortion corrector for correcting a distortion of angle of view in the pixels extracted by the image extractor when the camera captures an image; and
a controller for determining whether a setup shot mode is set to a self-view mode for capturing the user, controlling the shot mode of the camera at the self-view mode when the setup shot mode is set to the self-view mode, and controlling the transmission/reception unit to transmit an image having no distortion of angle of view through the distortion corrector to the called party's communication terminal.

2. The apparatus as set forth in claim 1, wherein the tracker detects a center point of the user's face area extracted from the captured image of the camera, and the image extractor extracts predetermined pixels covering the user's face area on the basis of the center point of the user's face area, and constructs a screen image using only the extracted pixels.

3. The apparatus as set forth in claim 2, wherein the controller determines whether the user's face area detected by the tracker is in a prescribed allowable range, determines whether a user's face area corresponding to the pixels corrected by the distortion corrector is in a prescribed allowable range, and
if at least one of the user's face area detected by the tracker is outside of the prescribed allowable range, and the user's face area corresponding to the pixels corrected by the distortion corrector is outside of the prescribed allowable range, the controller controls the transmission/reception unit to prevent the image having no distortion of angle of view from being transmitted.

4. The apparatus as set forth in claim 3, further comprising:
an alarm signal generator for generating an alarm signal recognizable to the user upon receiving a control signal from the controller,
wherein, if at least one of the user's face area detected by the tracker is outside of the prescribed allowable range, and the user's face area corresponding to the pixels corrected by the distortion corrector is outside of the prescribed allowable range, the controller controls the alarm signal generator to output the alarm signal.

5. The apparatus as set forth in claim 4, further comprising:
a display for displaying an image received at the transmission/reception unit; and
a storage unit for storing the image displayed on the display according to a control signal of the controller.

6. A method for displaying a user's face area at the center of a display screen in a communication terminal apparatus with a camera for transmitting a captured image to a communication terminal of a called party, and displaying an image received from the called party's communication terminal thereon to establish a video communication with the called party, said method comprising the steps of:
a) detecting the user's face area from an image captured by the camera;
b) selecting pixels of a predetermined range covering the detected user's face area;
c) correcting a distortion of angle of view in an image corresponding to the pixels covering the user's face area when the camera captures an image; and
d) transmitting an image having no distortion of angle of view to the called party's communication terminal.

7. The method as set forth in claim 6, further comprising the step of:
e) detecting a center point of the user's face area extracted from the captured image of the camera after performing the step (a),
wherein step (b) further includes the step of extracting predetermined pixels covering the user's face area on the basis of the center point of the user's face area.

8. The method as set forth in claim 7, further comprising the steps of:
f) determining whether the user's face area detected at step (a) is in a prescribed allowable range after performing step (c), determining whether the user's face area corresponding to the pixels corrected at step (c) is in a prescribed allowable range; and
g) if at least one of the user's face area is outside of the prescribed allowable range, and the user's face area corresponding to the pixels is outside of the prescribed allowable range, preventing the image having no distortion of angle of view from being transmitted to the called party's communication terminal.

9. The method as set forth in claim 8, further comprising the step of:
h) if at least one of the user's face area is outside of the prescribed allowable range at step (f), and an image area corresponding to the pixels covering the user's face area is outside of the prescribed allowable range, outputting an alarm signal recognizable to the user.
